(19) United States
(12) Patent Application Publication
(10) Pub. No.: US 2008/0054236 A1
(43) Pub. Date: Mar. 6, 2008

(54) Method of installing a conduit, innerduct, and cable

(76) Inventor: David D. Morris, Newman, GA (US)

Correspondence Address: Jeffrey E. Bacon;Legal Department, M-495, P.O. Box 1926, Spartanburg, SC, 29304, US

(21) Appl. No.: 11/845,826

(22) Filed: Aug. 28, 2007

Related U.S. Application Data
(60) Provisional application No. 60/841,645, filed on Aug. 31, 2006.

(51) Int. Cl. H02G 1/08

(52) U.S. Cl. 254/134.4

(57) ABSTRACT

Flexible textile innerducts are provided with multiple longitudinal chambers. A conduit is formed with the flexible textile innerducts disposed internally. After the conduit is formed with the flexible textile innerducts therein, the conduit is positioned in the use position by burying the conduit or locating it within a body. A cable is disposed within the longitudinal chambers of the flexible innerducts with the use of a pull line or by blowing the cable into the longitudinal chamber.

### CROSS-REFERENCE TO RELATED APPLICATIONS

This non-provisional application claims priority to U.S. Provisional Application No. 60/841,645, filed Aug. 31, 2006.

### BACKGROUND

Textile innerducts are known for use in conduits to facilitate installing cables and to separate the cables installed inside a conduit. Under the prior art methods using an innerduct, the conduit is positioned into its intended location prior to installing a textile innerduct into that conduit. The textile innerduct is installed into the conduit by pulling, blowing, or the like. Subsequent to installing the innerduct within the conduit, one or more cables are installed in the appropriate chambers of the innerduct. The cables are installed within the innerduct by blowing the cable through the innerduct, using a pull tape or rope to pull the cable through the innerduct, or the like. However, this process entails substantial effort to install the innerduct once the conduit is in position. Therefore, there is a need for devices and systems that can reduce the efforts to install the innerduct and, therefore, the total installation process effort.

### BRIEF DESCRIPTION OF THE DRAWINGS

FIG. 1 shows a prospective cutaway view of a conduit, innerduct, and pull tape, and/or cable assembly that can be used in the present invention; and

FIG. 2 shows a block diagram showing one embodiment of the installation method of the present invention.

### DETAILED DESCRIPTION

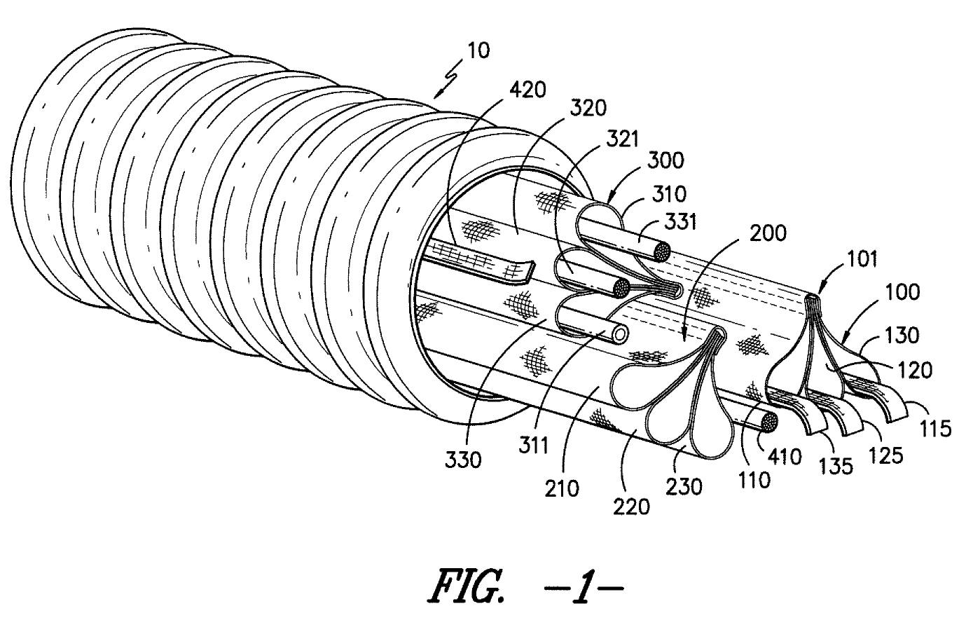

Referring now to FIG. 1, there is shown a conduit 10 with flexible innerducts 100, 200, and 300 disposed therein. A conduit cable 410 and a conduit pull line 420 can also disposed within the conduit 10. The flexible innerducts 100, 200, and 300, have innerduct chambers 110/120/130, 210/220/230, and 310/320/330, respectively. Although the flexible innerducts 100, 200, 300 have been illustrated with multiple innerduct chambers, the flexible innerducts 100, 200, 300 can have a single innerduct chamber, two innerduct chambers, or more than two innerduct chambers.

Disposed within the innerduct chambers 110, 120, and 130 of the flexible innerduct 100, are the pull lines 111, 121, 131, or tapes. The pull lines 111, 121, and 131, extend the length of the longitudinal cavities of the innerduct chambers 110, 120, and 130, respectively. The pull lines 111, 121, and 131 are strands of material for the pulling of cables through the respective innerduct chambers 110, 120, and 130. Alternatively, various innerduct chambers of the flexible innerduct 100 can be empty, such as illustrated with respect to flexible innerduct 200 and the associated innerduct chambers 210, 220, and 230. In yet another embodiment, a cable or cables can be disposed within various innerduct chambers 110, 120, and 130 of the flexible innerduct 100, such as illustrated with respect to cables 315, 325, and 335 disposed within the associated innerduct chambers 310, 320, and 330 of the flexible innerduct 300.

As illustrated, the flexible innerducts 100, 200, and 300 are flexible textile innerducts. The textile innerduct 100 has a strip or strips of textile material forming the innerduct chambers 110, 120, and 130. The textile forming each of the innerduct chambers 110, 120, and 130 are joined by a seam 101 at the outside edge of the textile innerduct 100. Similarly, textile innerducts 200 and 300 are a strip or strips of textile material joined to form associated innerduct chambers 210, 220, and 230 and 310, 320, and 330, respectively.

The textile innerduct 100 has warp yarns running substantially longitudinal to the textile innerduct 100, and fill yarns running substantially perpendicular to the textile innerduct 100. In one embodiment, the textile material forming the textile innerduct 100 is a plain woven fabric having 33 ends per inch of 520 denier polyester monofilament warp yarns in the longitudinal direction, and 32 picks per inch of 520 denier nylon 6 monofilament fill yarns in the cross direction. In another embodiment, the textile material forming the textile innerduct 100 is a plain weave fabric having 50 ends per inch of 520 denier polyester monofilament warp yarns and 28 picks per inch of 350 denier nylon 6 monofilament fill yarns. In yet another embodiment, the textile material forming the textile innerduct 100 is a plain weave fabric having 50 ends per inch of 520 denier polyester monofilament warp yarns and a “pick and pick” fill of alternating 350 denier nylon 6 monofilament yarns and 2 ply 300 denier polyester multifilament yarns. Although these examples provide possible yarns and configurations, others are possible such as the use of polypropylene. The textile innerducts 200 and 300 can be textile innerducts of the same construction as the textile innerduct 100.

Although the textile innerducts for the flexible innerducts 100, 200 and 300 have been described with respect to a particular construction, other constructions of textile innerducts can be used in the present invention. For example, the textile innerduct described in U.S. Pat. No. 6,304,698 (the “'698 patent”), “Conduit Insert for Optical Fiber Cable”, issued on Oct. 16, 2001, which is hereby incorporated in its entirety by reference specifically hereto, can be used as one or more of the flexible textile innerducts 100, 200, and 300. The alternative textile innerduct, as described in the '698 patent, can have multiple chambers formed by layers of a fabric joined together at the outside edges of the layers. The layers of fabric can be formed by separate strips, or by single strip which is folded over itself in the width direction. The layers of fabric can have different widths, thereby forming innerduct chambers with a bias for an open position. By using a polyester monofilament warp for strength in the longitudinal direction, and nylon monofilament as fill in the cross direction for an open bias, the internal chambers formed by the varying width strips will be disposed in an open condition. In yet another embodiment, the textile innerducts 100, 200, and 300 are constructed with yarns formed with a material containing a flame retardant additive, such as melamine cyanurate, extruded within the yarn to impart fire resistance. Embodiments of the invention using fire resistant material are described in U.S. Pat. No. 6,718,100, issued to David Drew Morris on Apr. 6, 2004, entitled “Fire Resistant Conduit Insert for Optical Fiber Cable”, which is hereby incorporated in its entirety by specific reference thereto.

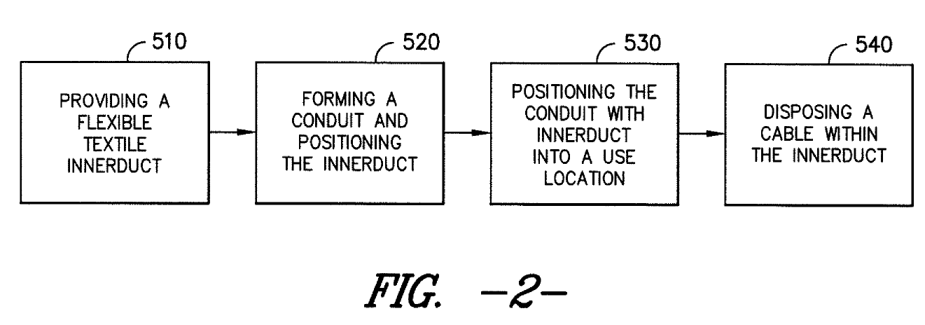

Referring now to FIG. 2, there is shown a block diagram illustrating one embodiment of a method in the present invention. As illustrated, the method begins with the step 510 of providing a flexible innerduct, such as the flexible innerduct 100, 200, and 300 in FIG. 1. The flexible innerduct has at least one longitudinal innerduct chamber, but can have two or more. The flexible innerduct provided can be a textile innerduct, such as described with respect to flexible textile innerducts 100, 200, or 300, above. At least one flexible innerduct is provided for subsequent processing; however, two or more flexible innerducts can be used in the process. Where multiple flexible innerducts are used, they may be of the same configuration or of different configurations. In one embodiment, a pull line or pull lines are positioned within the innerduct chambers of the flexible innerduct that is provided.

Following the step 510 of providing the flexible innerduct(s), in a step 520 the conduit is formed and the flexible innerduct(s) being positioned longitudinally within the conduit. A single flexible innerduct can be placed within the conduit, or multiple flexible innerducts can be placed within the conduit. Typically, the flexible innerduct(s) is (are) positioned within the conduit simultaneously as the conduit is being formed, such as in a co-extrusion process. The conduit with the flexible innerduct(s) therein can be formed in shorter lengths such as one (1) to fifty (50) meters, but greater advantages can be had by forming longer lengths such as fifty (50) to five hundred (500) meters, or greater. The flexible innerduct(s) is (are) positioned longitudinally within the conduit such that flexible innerduct can slide within the conduit. In an embodiment where the flexible innerduct is a textile innerduct with warp yarns, the warp yarns of the textile innerduct are positioned longitudinally with the conduit, and the fill yarns are positioned in a cross direction substantially perpendicular to the longitudinal direction. In one embodiment, the conduit is extruded from a high density polyethylene. Step 520 can also include the incorporation with the flexible innerduct in the conduit, a cable and/or a pull line which are within the conduit and outside of the flexible innerduct(s), such as cable 410 and pull line 420 in FIG. 1.

Following the step 520 of forming the conduit and positioning the flexible innerduct(s) within the conduit, in a step 530 the conduit with the flexible innerduct(s) therein is positioned into the location for use of the conduit. In most situations, positioning of the conduit requires digging a trench in the ground for the conduit, locating the conduit within the trench, and then burying the conduit. However, the conduit can also be positioned by locating the conduit within passageways of a body that are intended for the conduit. In addition to the steps listed above, the method can include the steps of placing the conduit with the flexible innerduct therein on a spool or reel after the step 520 of forming the conduit and before the step 530 of positioning the conduit, transporting the conduit on the spool or real, and unreeling the flexible innerduct from the spool or real before the positioning of the conduit in step 530.

Following the step 530 of positioning of the conduit with the flexible innerducts located therein, in a step 540 a cable is disposed within an innerduct chamber of a flexible innerduct. In a first embodiment, the cable can be positioned by using a pull line previously positioned within the flexible innerduct chamber to draw the cable through the flexible innerduct into position. Alternatively, the cable can be blown into position within the innerduct chamber of the flexible innerduct. The step 540 of disposing the cable within an innerduct chamber of the flexible innerduct can be repeated as many times as needed and for different innerduct chambers of the flexible innerduct and for different innerduct chambers of other flexible innerducts within the conduit. Additionally, the pull line inserted into the conduit and outside of the flexible innerducts, can be used to pull additional flexible innerducts or cables after the conduit is positioned.

What is claimed is:

1. A method comprising the steps of:
a) providing a flexible innerduct having at least one longitudinal innerduct chamber;
b) forming a conduit and positioning the flexible innerduct longitudinally within the conduit;
c) positioning the conduit containing the flexible innerduct in the use location after the step of forming the conduit and positioning the flexible innerduct within the conduit; and
d) disposing a cable within the longitudinal innerduct chambers of the flexible innerduct within the conduit after the conduit has been positioned in the use location.

2. The method of claim 1, wherein the step of providing the flexible innerduct includes providing the flexible innerduct with more than one longitudinal innerduct chamber.

3. The method of claim 1, wherein the step of providing the flexible innerduct includes positioning a cable longitudinally in the longitudinal innerduct chamber.

4. The method of claim 1, wherein the step of providing a flexible innerduct includes the flexible innerduct provided being a textile innerduct.

5. The method of claim 4, wherein the textile innerduct provided includes warp yarns and the step of forming the conduit and postioning the flexible innerduct includes positioning the warp yarns in the longitudinal direction of the conduit.

6. The method of claim 4, wherein the textile innerduct provided further includes fill yarns, and the step of forming the conduit and positioning the flexible innerduct includes positioning the fill yarns substantially perpendicular to the longitudinal direction of the conduit.

7. The method of claim 1, wherein the step of providing a flexible innerduct includes providing at least one additional flexible innerduct, and the step of forming the conduit and positioning the flexible innerduct longitudinally within the conduit includes positioning the additional innerduct longitudinally within the conduit with the first flexible innerduct.

8. The method of claim 1, wherein the step of forming the conduit and positioning the flexible innerduct includes simultaneously positioning the innerduct within the conduit during formation of the conduit.

9. The method of claim 8, wherein the step of forming the conduit and positioning the flexible innerduct includes coextruding the conduit with the flexible innerduct.

10. The method of claim 1, wherein the step of forming the conduit and positioning the flexible innerduct within the conduit includes positioning a cable longitudinally in the conduit and outside of the flexible innerduct.

11. The method of claim 1, wherein the step of positioning the conduit includes digging a trench in the ground, positioning the conduit with the flexible innerduct therein into the trench, and burying the conduit with ground.

12. The method of claim 1, further including the steps of placing the conduit with the flexible innerduct therein on a spool or reel and transporting the conduit with the innerduct therein to the use location, and unreeling the conduit before the step of positioning the conduit with the flexible innerduct therein into the use location.

13. The method of claim 1, wherein the step of providing a flexible innerduct includes providing a pull line longitudinally within the innerduct chamber, and wherein the step of disposing the cable within the flexible innerduct includes drawing the cable within the flexible innerduct chamber with the pull line.

14. The method of claim 1 wherein the step of disposing the cable within the flexible innerduct includes blowing the cable longitudinally within the inner chamber.

15. The method of claim 1, wherein the step of forming the conduit and positioning the flexible innerduct within the conduit includes positioning a conduit pull line longitudinally in the conduit and outside of the flexible innerduct.

16. The method of claim 15, further including the step of using the conduit pull line to pull a cable longitudinally within the conduit and outside of the flexible innerduct after the conduit has been positioned in the use location.

17. The method of claim 15, further including the step of using the conduit pull line to pull another flexible innerduct longitudinally within the conduit and outside of the flexible innerduct after the conduit has been positioned in the use location.
